(19) United States
(12) Patent Application Publication
(10) Pub. No.: US 2019/0300099 A1
(43) Pub. Date: Oct. 3, 2019

(54) Bicycle rear article carrier convertable to a single-wheeled trailer

(71) Applicant: Tom S. THOMAS, Gabriola Island (CA)

(72) Inventor: Tom S. THOMAS, Gabriola Island (CA)

(21) Appl. No.: 15/940,020

(22) Filed: Mar. 29, 2018

(51) Int. Cl. B62K 27/00; B62K 27/12

(52) U.S. Cl. CPC B62K 27/006; B62K 27/12

(57) ABSTRACT

A bicycle rear article carrier that converts into a single-wheeled trailer is disclosed. The carrier is nearly indistinguishable in appearance and utility from conventional rear carriers, however, its folding and/or telescoping mechanisms incease bicycle cargo carrying capacity by a significant factor. A 12 inch quick-release wheel that is integral to the trailer unit can be stowed on the side of the rack without undue diminishment to carrier utility. If defined strictly as a trailer, the unit ‘disappears’ and becomes fully integrated with the bicycle by a few quick moves, comprising a system of ergonomic efficiency, space economy and convenience.

### FIELD OF THE INVENTION

This invention relates to bicycle cargo racks, bicycle article carriers, bicycle trailers, hitches and related cargo carrying methods.

A number of existing art examples that expand the capacity of the rear article carrier can be referenced. U.S. Pat. No. 8,910,842 B2 employs an outrigger system, while U.S. Pat. No. 3,934,770A comprises collapsible baskets. With respect to the trailer function of this invention, U.S. Pat. Nos. 4,756,541, 660,598, 5,011,170, 5,076,600, 5,171,034 and 5,641,173 disclose single-wheeled trailers. Canadian Patent 02693111 is relevant because it discloses a dual purpose single-wheeled trailer. The disclosure of this invention herein is preceded by the author's Canadian Patent application 2,952,313.

### BACKGROUND OF THE INVENTION

Bicycle trailers can be divided into two broad categories, single and dual wheeled, and may be further sub-divided by towing method, mainly, axle and seatpost pulled. A further classification can be made according to utility: single-purpose trailers and trailers incorporating off-bicycle functionality such as cart capability and space-saving features.

Whereas the two wheeled trailer can be said to be ‘rotationally independent’ from the bicycle, thereby exerting minimum force onto same, the opposite is true of the single wheel trailer which, proportional to the load carried, exerts tremendous torsion and vibration directly onto the bicycle, risking instability.

A significant advantage of the single wheel trailer, however, is better tracking, cornering, and viability on uneven terrain, particularly on narrow paths—dual wheeled trailers become unwieldy, even hazardous with respect to the latter.

All bicycle trailers entail ergonomic and mechanical issues comprising a) relative convenience/speed of hitching, b) maneuverability in tight spaces/parking, c) load capacity, d) constructed weight, e) storage

As will become evident on further reading of this application, this invention represents a breakthrough solution to the problem of storage because the trailer integrates completely with the bicycle while also increasing load capacity when in rear carrier mode.

### SUMMARY OF THE INVENTION

The primary purpose of this invention is to provide a lightweight, compactible single-wheeled trailer that integrates with the bicycle in the form of a rear article carrier.

A significant feature of this invention is a quick-release wheel that stows on the towing frame when the unit is in carrier mode, lending both utility and aesthetic touch.

Another significant aspect of this invention is that compared to the standard conventional rear article carrier, the effective cargo ‘footprint’ is increased by approximately 50%. That in trailer mode the effective cargo footprint is 300% greater.

An important aspect of this invention is the ergonomic ease by which the trailer is deployed. In five successive moves the trailer is ready to take on cargo, as follows: 1. the rider in standing position releases the docking/lock mechanism, 2. the platform is unfolded, 3. the quick-re lease wheel is removed from its hook and attached to the trailer's drop-outs, 4. The entire unit is lowered to the ground, 5. the axel extender nuts are tightened and locked. The entire process should ideally take less than 30 seconds.

Another aspect of this invention is an alternative method of construction whereby identical over-all utility is achieved. The method would entail a telescoping mechanism instead of the folding method disclosed in this application. Whereas from a manufacturing point of view there are pros and cons to each method, the preferred method shall entail folding as described in this application. The telescoping alternative is described briefly herein for reference only.

### BRIEF DESCRIPTION OF THE DRAWINGS

FIGS. 1, 1A and 2 depict side views of the three functional modes of the invention: rear article carrier, rear article carrier with stowed wheel, trailer with load.

FIG. 3 shows isometric view of collapsed platform unit; FIG. 3A shows isometric view of expanded platform unit and raised swing tube.

FIG. 4 is a top view of the primary platform; FIG. 4A is a rear isometric view of the primary platform.

FIGS. 5 and 5A are partial front isometric view of primary platform depicting spring pin, clamp and swing stop mechanisms.

FIG. 6 is a partial isometric view of primary platform depicting details of clamp and swing stop mechanisms.

FIG. 7 is a top view of the secondary expansible platform. FIG. 7A is an isometric view of the secondary expansible platform.

FIG. 8 is a right isometric view of the complete collapsed unit in ‘on-bike’ position.

FIG. 9 is a left side view of the complete collapsed unit in ‘on-bike’ position.

FIGS. 10 and 10A are side views depicting the swing motion of the tow frame and unfolding actions of the primary and expansible platforms.

FIG. 11 is a left view of the complete trailer unit in ground position; FIG. 11A is a left isometric view of the complete trailer unit in ground position.

FIG. 12 is a right side view of the tow frame; FIG. 12A is a side view showing fastening detail of turning axle to tow frame; FIG. 12B is a left isometric view of the tow frame.

FIG. 13 is an isometric view of the bicycle nut extender assembly; FIG. 13A is an isometric detailed view of the bicycle nut extender assembly.

FIG. 14 is an isometric view of the bicycle nut extender assembly showing the swing action of the bolt locking mechanism.

FIG. 15 is an isometric view of swing tube and turning axle assembly.

FIG. 16 is an isometric view of swing tube and turning axle assembly showing bushings application for turning axle. FIG. 16A is an isometric view of swing tube and turning axle assembly showing sealed ball-bearings application for turning axle. FIG. 16B is an isometric view showing swing axle stop mechanism.

FIG. 17 is an isometric view of the platform clamp lock mechanism that secures unit to the bicycle; FIG. 17A is a left side view of the platform clamp lock mechanism.

FIGS. 18 and 18A are isometric views of alternative method of fabrication of this invention for reference purposes only.

FIG. 19 is a right side view of the complete collapsed unit in ‘on-bike’ position with wheel in stow position.

### DETAILED DESCRIPTION OF THE INVENTION

This invention comprises five distinct component assemblies or units:
1. primary platform, 2. secondary expansible platform, 3. axle assembly, 4. tow frame, 5. clamp bracket

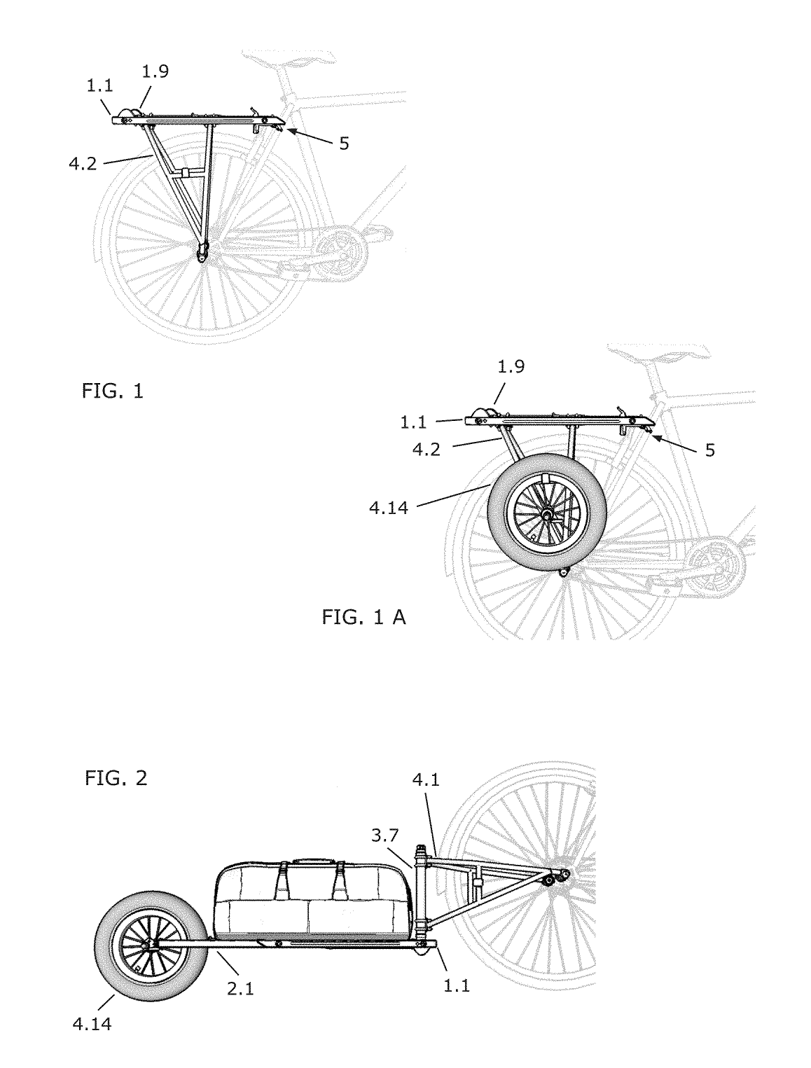

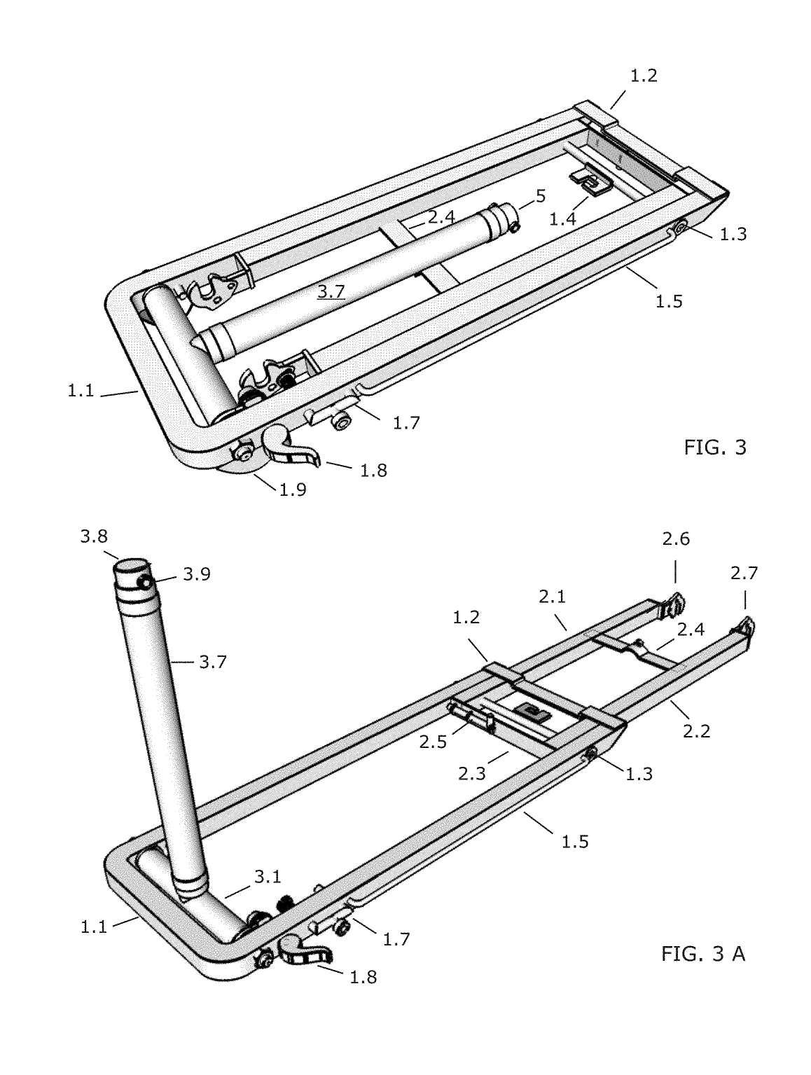

There are three functional modes to this invention as depicted in FIGS. 1, 1A and 2. FIG. 1 shows the rear article carrier mode in which the primary and expansible platforms, 1, 2, are folded together to form a single platform unit, whereby the tow frame, 4, forms an upright support of said carrier/platform unit. Whereby the entire unit is secured to bicycle by clamp bracket, 5.

FIG. 1A depicts the rear article carrier mode with quick-release wheel, 4.14, in stow mode attached to hook, 4.5.

FIG. 2 shows the invention in trailer mode with suggested load; where by the entire unit has been lowered to the ground via swivel action through the bicycle axle nut extender units, 4.15, 4.16. Whereby the load is strapped to the primary platform, 1, by hooks attached to strap hook bars, 1.5, 1.6.

Proceeding with the primary platform, 1, and its constituent parts: the main frame 1.1 is substantially a rectangular form comprised of tubular steel or other suitably strong material whereby the longer tubelar lengths are joined by welding at the shorter end by a flatbar crossmember, 1.2.

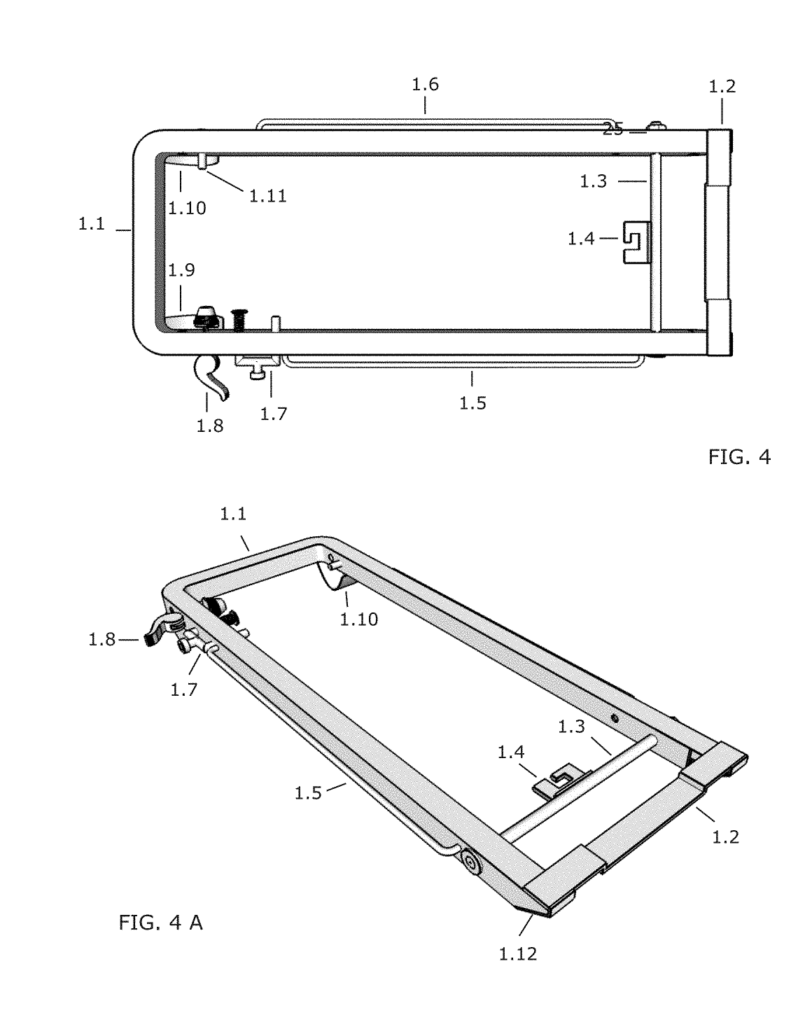

Continueing with the primary platform, FIGS. 4, 4A, its constituent parts comprise provisions as follows: drilled holes to accommodate swing stop mechanism pins, 1.7, 1.8, 1.11, swing stop tab covers, 1.9, 1.10, strap hook bars, 1.5, 1.6, crossmember bolt, 1.3, to receive expansible platform, 2, and female latch plate welded to said bolt, 1.4, which connects to clamp bracket, 5.

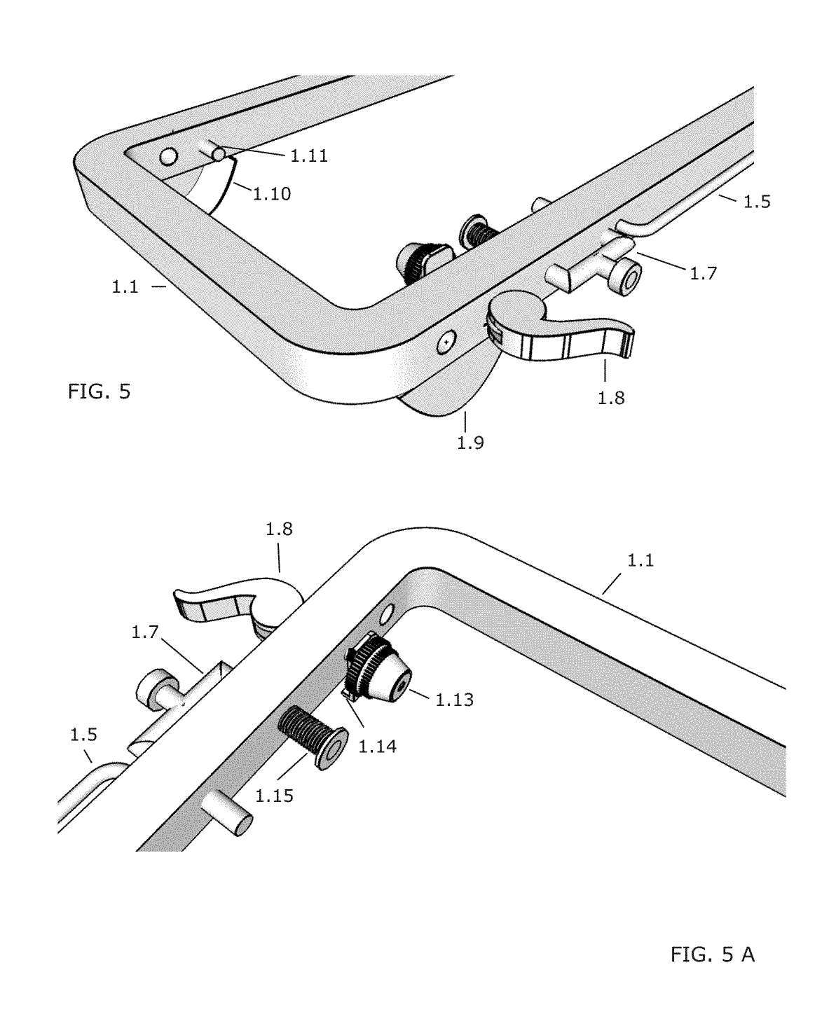

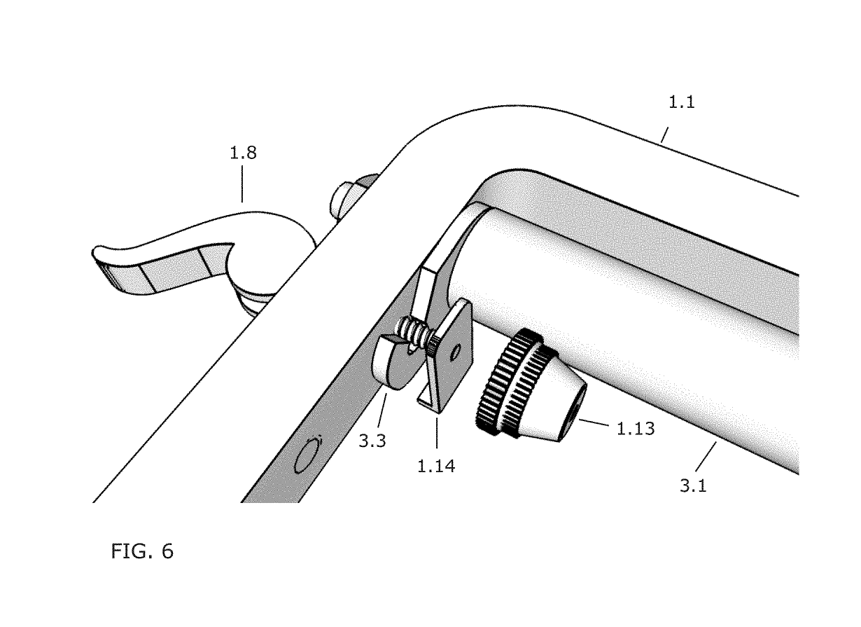

Proceeding now with primary platform component details, FIGS. 5, 5A and FIG. 6. Component 1.8 is a quick-release clamp whose bolt functions as a stop for the swing tube stop tab, 3.3. Once tightened via nut, 1.13, it prevents axle assembly loose play. A lock tab, 1.4, prevents the axle assembly from jumping out of position when the trailer hits a bump in the road.

Component 1.7 is a u-shaped spring pin mechanism that locks and releases the expansible platform, 2, when collapsed into the primary platform, 1.

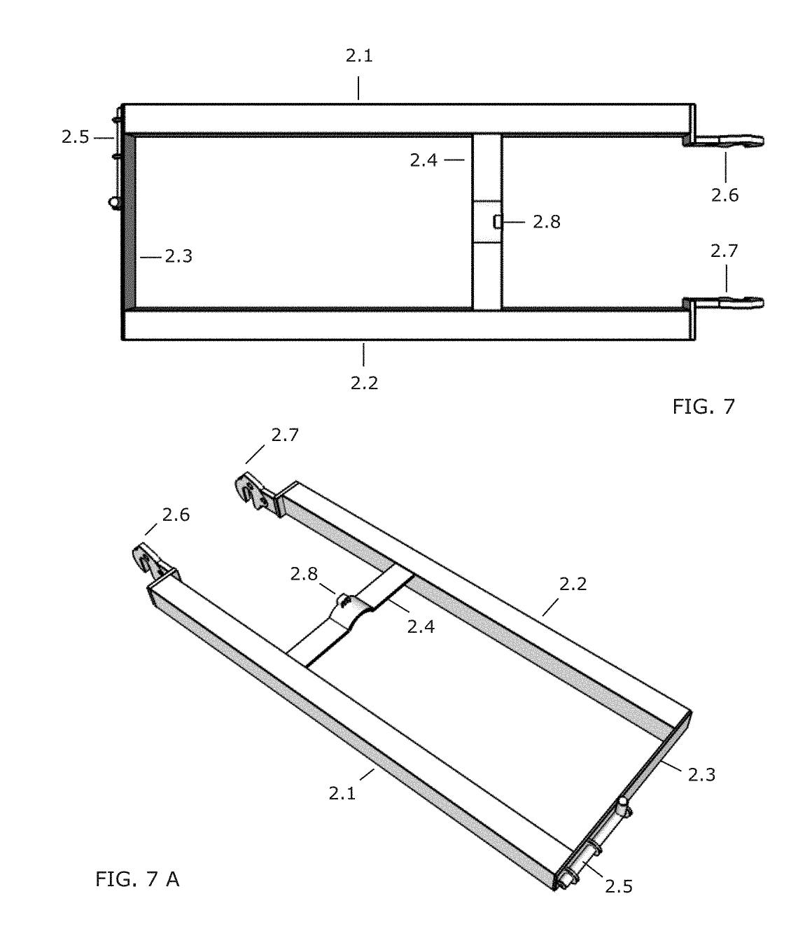

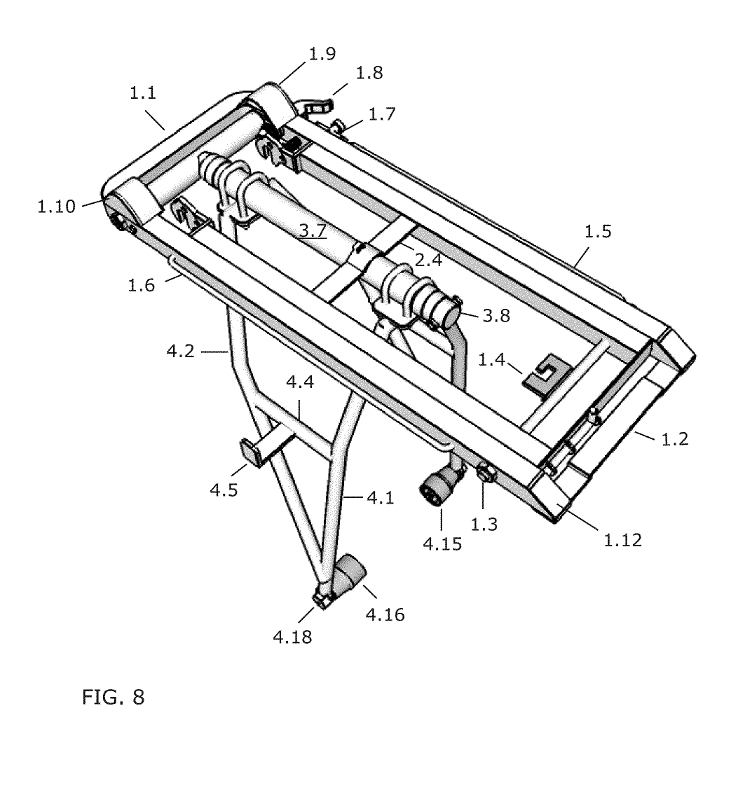

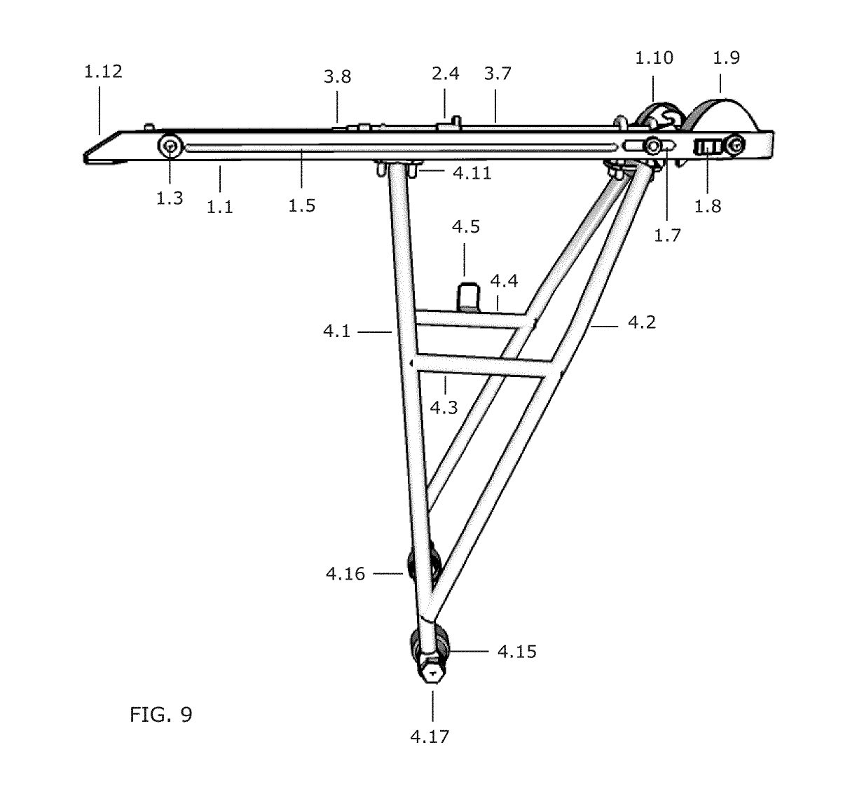

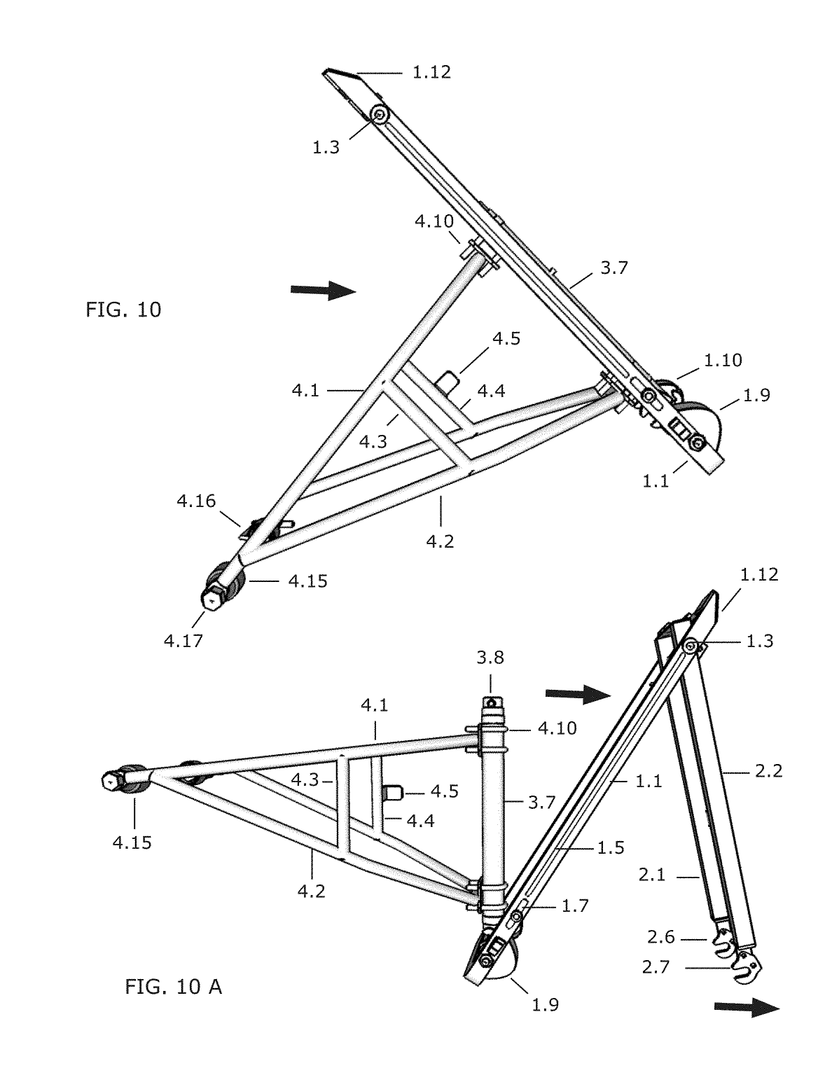

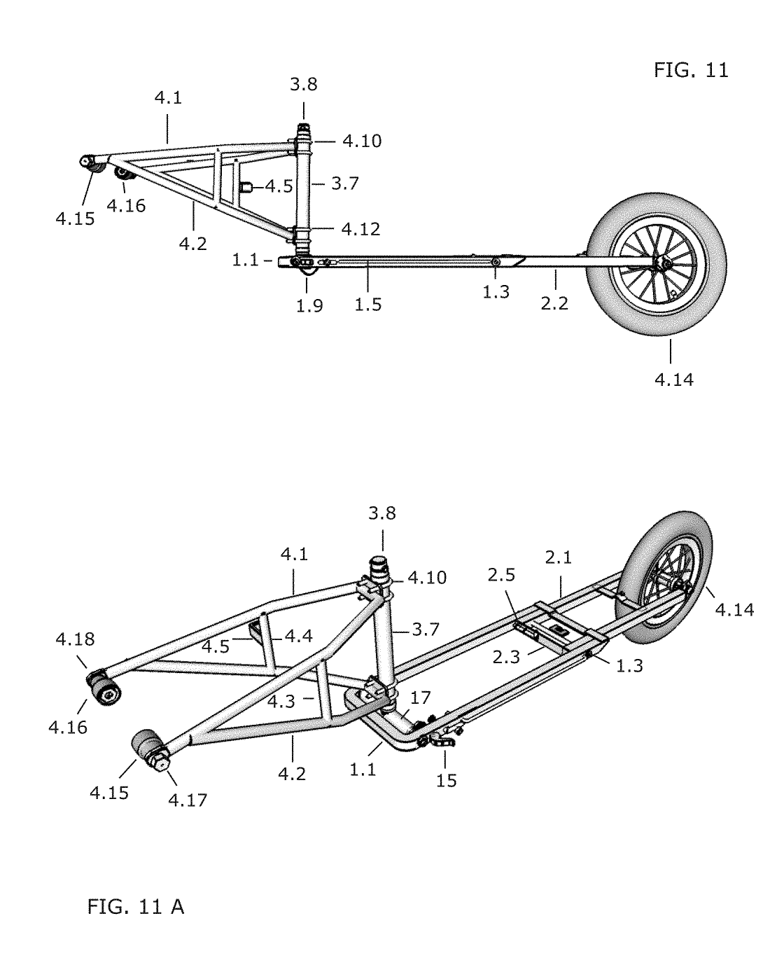

Moving on now to the expansible platform, 2, and its constituent parts: FIGS. 7 and 7A. A semi-U-shape comprising two tubelar sections, 2,1, 2.2, joined by welded flatbar cross-members, 2.3, 2.4. Whereby wheel axle drop-outs, 2.6, 2.7, are welded to the open ends of the tubelar sections. Whereby cross-member 2.4 has a slight u bend in its center to seat the turning axle, 3.7. Whereby item 2.8 is a threaded braze-on to accommodate fender attachment. Whereby item 2.5 is a spring bolt lock mechanism that locks into primary platform, 1.1, when in trailer mode.

Proceeding now to the axle assembly unit, 3. It is a T-formation whereby the horizontal section (the swing tube), 3.1, is welded to the vertical section (turning axle) comprising an inner tube, 3.8, and outer tube, 3.7, secured together by lynch pin 3.9. The inner tube is welded to the swing tube and rotates inside the outer tube which in turn is attached to the tow frame, 4.

The swing tube, 3.1, rotates around a bolt, 3.2, that attaches to the primary platform, 1.1, with nuts, 3.5, 3.6. Welded to the ends of the swing tube, 3.1, are swing limitation stop tabs, 3.3 and 3.4.

With respect to the axle assembly unit, 3, it is crucial that no free play exist whatsoever when in trailer mode. Free play resulting from poor materials and subsequent wear, inaccurate fitting or machining could pose a serious hazard as it would create a shimmying/vibration effect under load. Whereas free play in the swing tube, 3.1, can be eliminated via the clamp stop mechanism, 1.8, prevention of free play in the turning axle, 3.8, 3.7, requires high quality materials and precision machining.

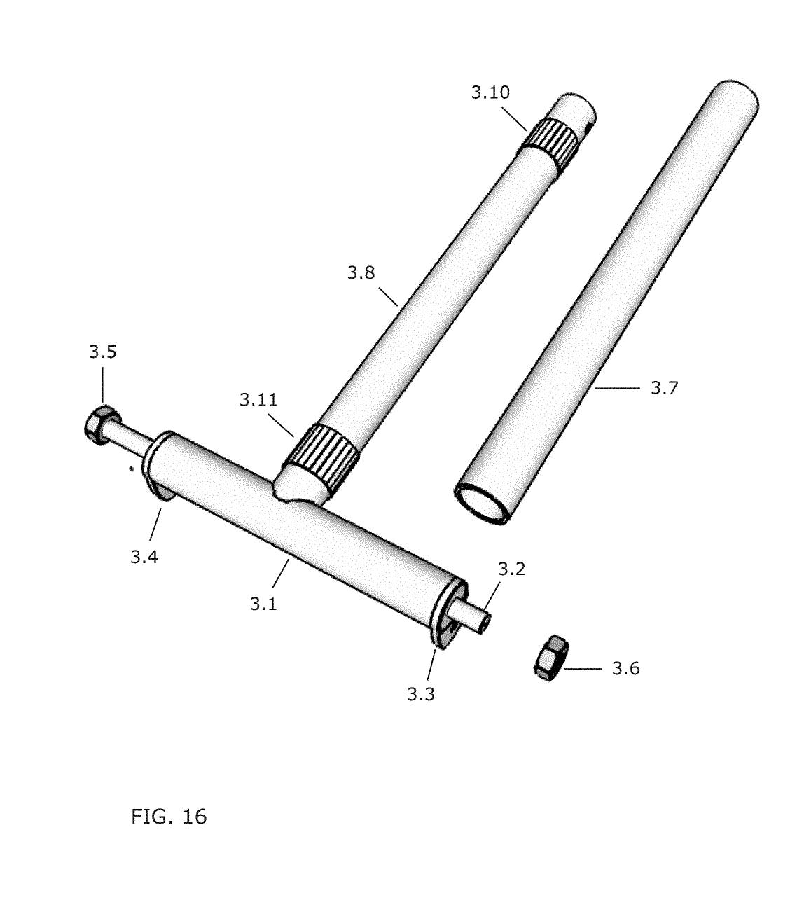

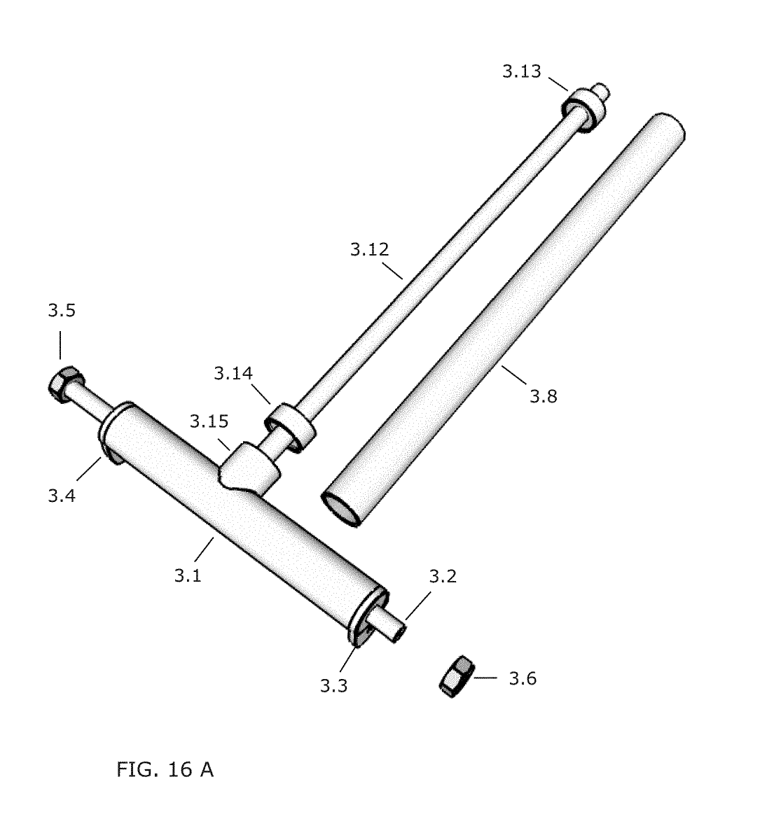

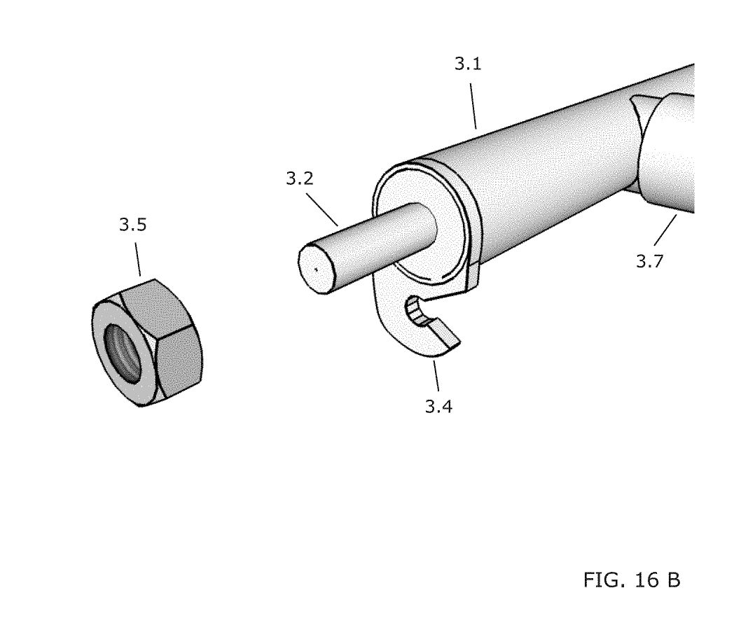

Two methods for the turning axle unit are proposed: FIG. 16 shows the more straightforward method of the two. It comprises replacable, wear-resistant (self-lubricating) bushings, 3.10, 3.11, fitted onto the inner tube axle, 3.8, which is welded to the swing tube, 3.1. The outer axle tube, 3.7, would be precision press-fitted onto the bushings.

The second method, FIG. 16A, entails the fitting of sealed ball-bearings, 3.13, 3.14, onto a rod, 3.12, which is either welded or screw mounted into a short base tube, 3.15, welded to the swing tube, 3.1. An outer axle tube, 3.8, is precision fitted onto the ball-bearing assembly.

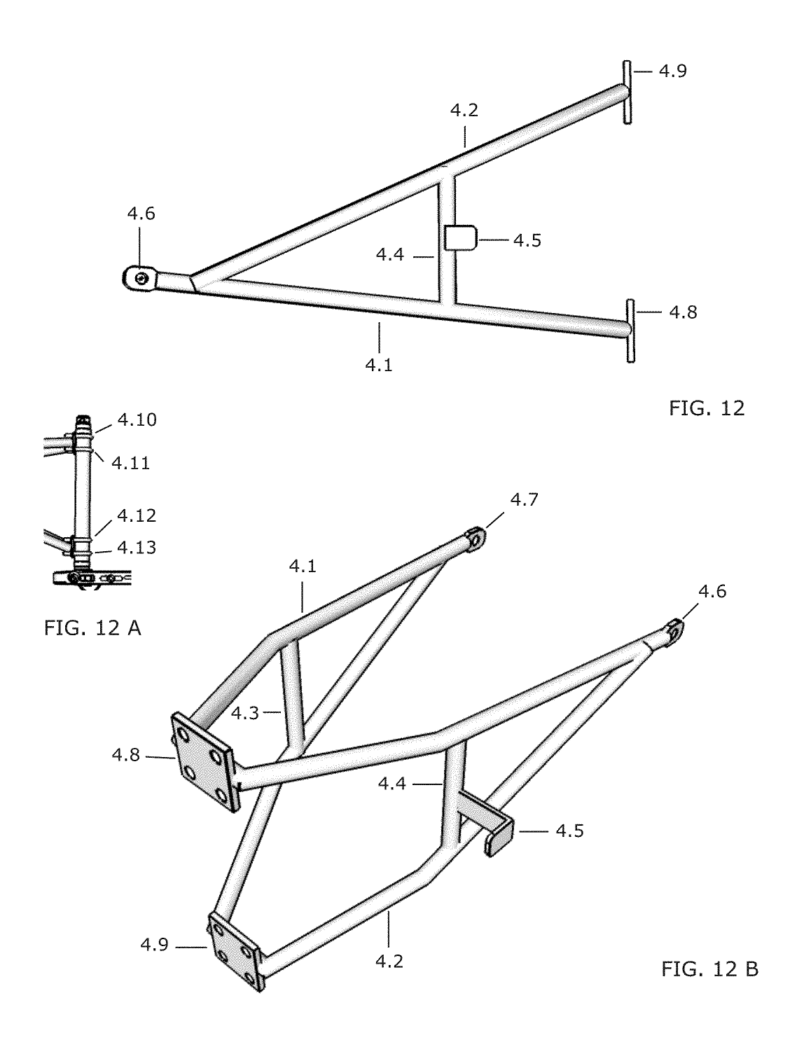

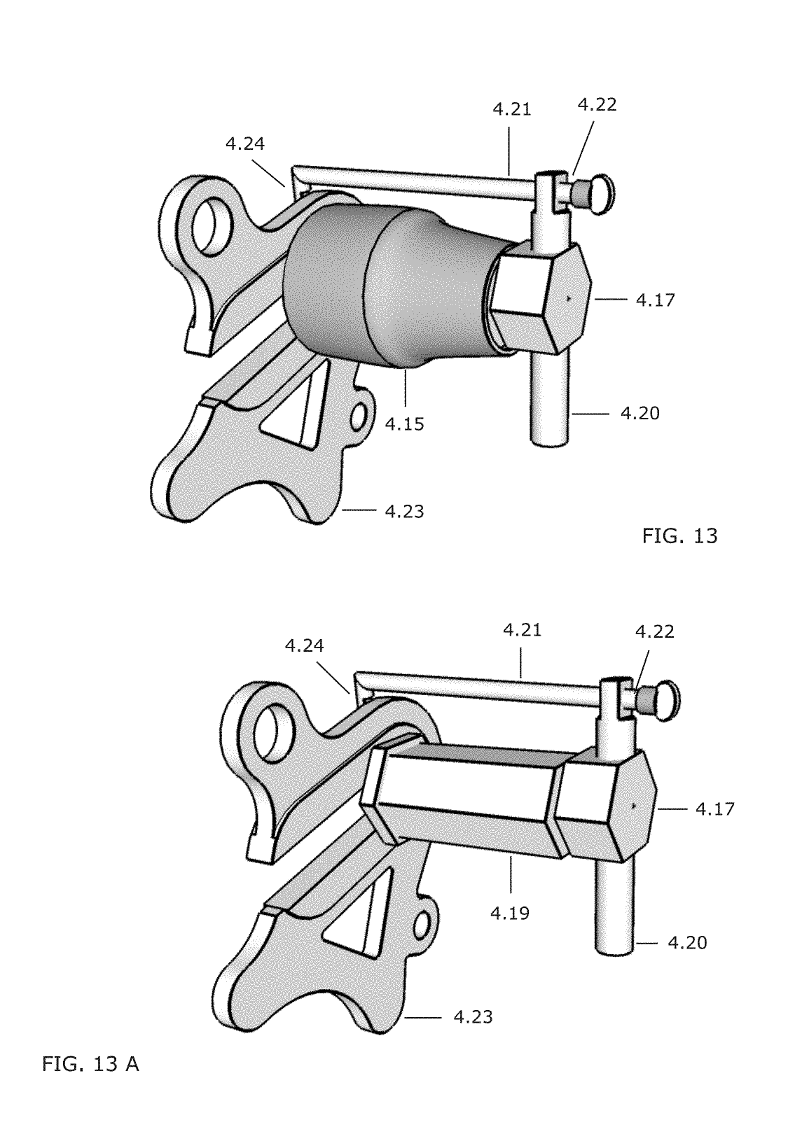

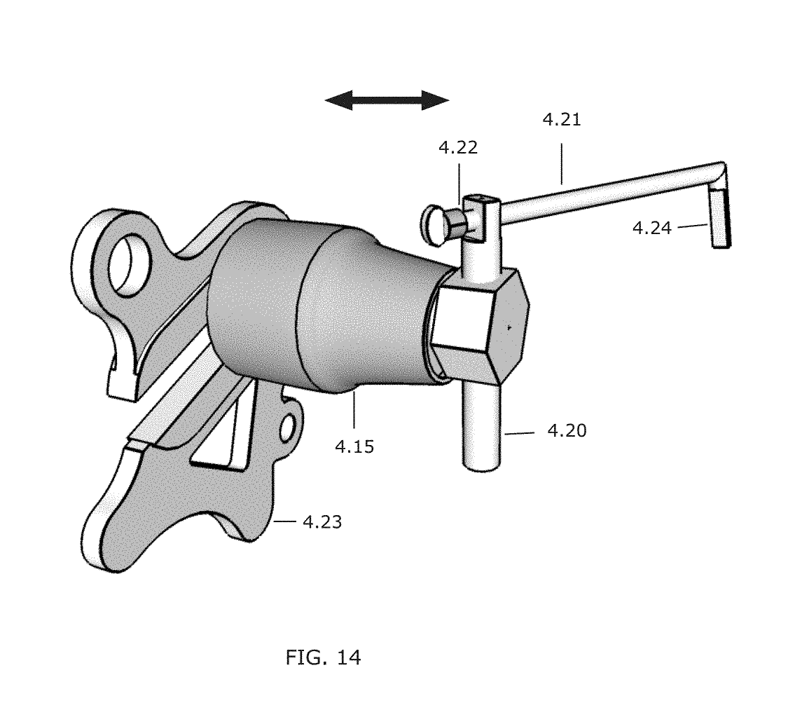

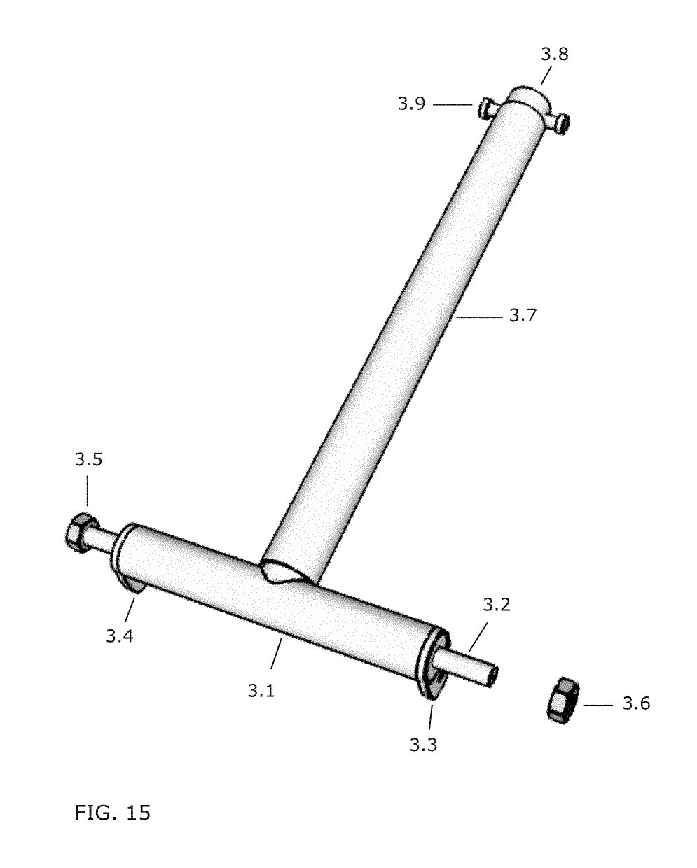

FIGS. 12, 12A and 12B refer to the tow arm component of this invention that doubles as the support frame of the carrier platforms, 1, 2, when in ‘on-bike’ carrier mode. It comprises two main tubing sections, 4.1, 4.2, that are bent in a substantially V formation. Whereby the open ends of one said tubing section is welded near the ends of other said tubing section at an approximate off-set angle of 28 degrees thereby forming a third V plane section FIG. 12. The said tubular V sections are further welded together by a multiplicity of short cross-member tubes, 4.3, 4.4. Whereby one of the short cross-member tubes has a hook welded to it, 4.5, that serves to hold the quick-release wheel, 4.14.

Whereby the open ends of the main V tube section, 4.1, are flattened and have drilled holes to receive the bicycle axle mounting bolts, 4.17. Whereby both V tube sections have anchor plates welded to them, 4.8, 4.9, FIG. 12B, to which the trailer's turning axle, 3.7, is bolted with u-bolts as shown in FIG. 12A, 4.10, 4.11, 4.12, 4.13.

FIGS. 13 and 13A depict the bicycle axle nut extender assembly, 4.15 through 4.24. The extender nut (elongated), 4.19, replaces the standard axle nut on the bicycle and is dual threaded in different gauge so as to take the tow frame fastening bolt, 4.17, at the other end. A spacer tube 4.15, takes the force of the fastening bolt and transfers it directly to the bicycle frame/drop-out. It is important that the two fastening elements function independently from each other because due to considerable vibration from the trailer in motion, the fastening bolt, 4.17, would cause the bicycle axle nut to loosen if their respective tightening forces were co-joined. As such, while the fastening bolt, 4.17, can be tightened considerably, the spacer permits sufficient friction movement so as to allow the tow arm, 4.1, to swivel which is essential for two reasons. Swivel articulation is necessary when compacting the trailer to carrier mode. Articulation is also crucial because it provides shock absorption on rough terrain or when hitting bumps on the road.

Accordingly, the fastening bolt, 4.17, must remain snug, but not lock tight. As vibration will eventually loosen it and cause it to fall off, a locking mechanism is necessary. Item 4.21 is a pin that hook latches to the backside of the bicycle drop-out and can be adjusted via thread 4.22 in order to maintain optimum tightness of fastening bolt, 4.17, and will pre vent it from falling off. FIG. 14 shows the swivel action of the bolt lock pin, 4.21, necessary so as to not interfere with the swivel action of the tow frame, 4.1, when compacting trailer/changing modes.

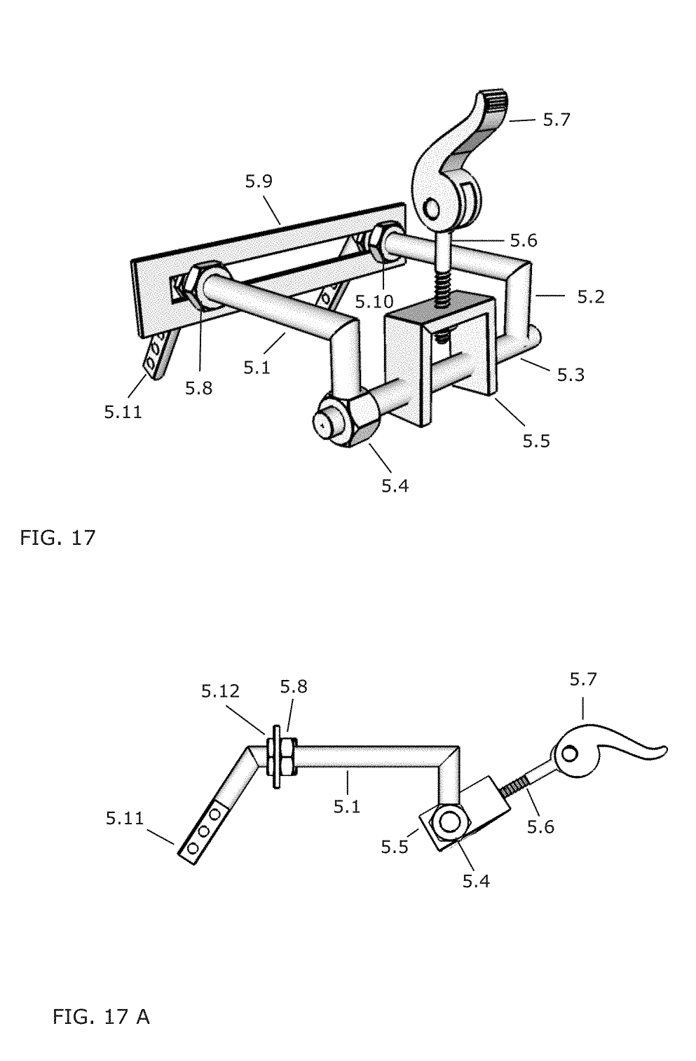

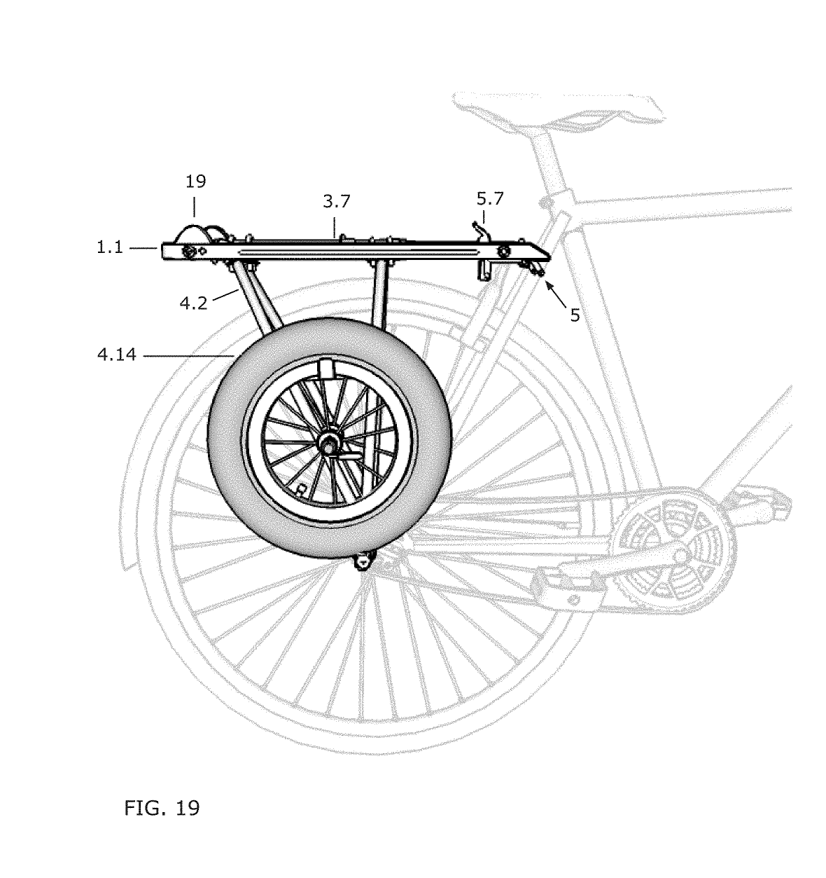

FIGS. 17 and 17A show the clamp bracket assembly, 5, that secures the platform in carrier mode to the bicycle. Two bent rods, 5.1, 5.2, each secured to the bicycle seat stays braze-ons via variable height holes, comprise the main structure FIG. 19. Bicycle seat stays will vary in width; accordingly the unit can be adjusted via slider plate, 5.9, and sliding rod/nut combination mechanisms, 5.3, 5.4. The quick-release swivel clamp, 5.7, 5.6, 5.5, attaches to the latch plate 1.4 located on the cross-member bolt, 1.3, on the primary platform, 1.1.

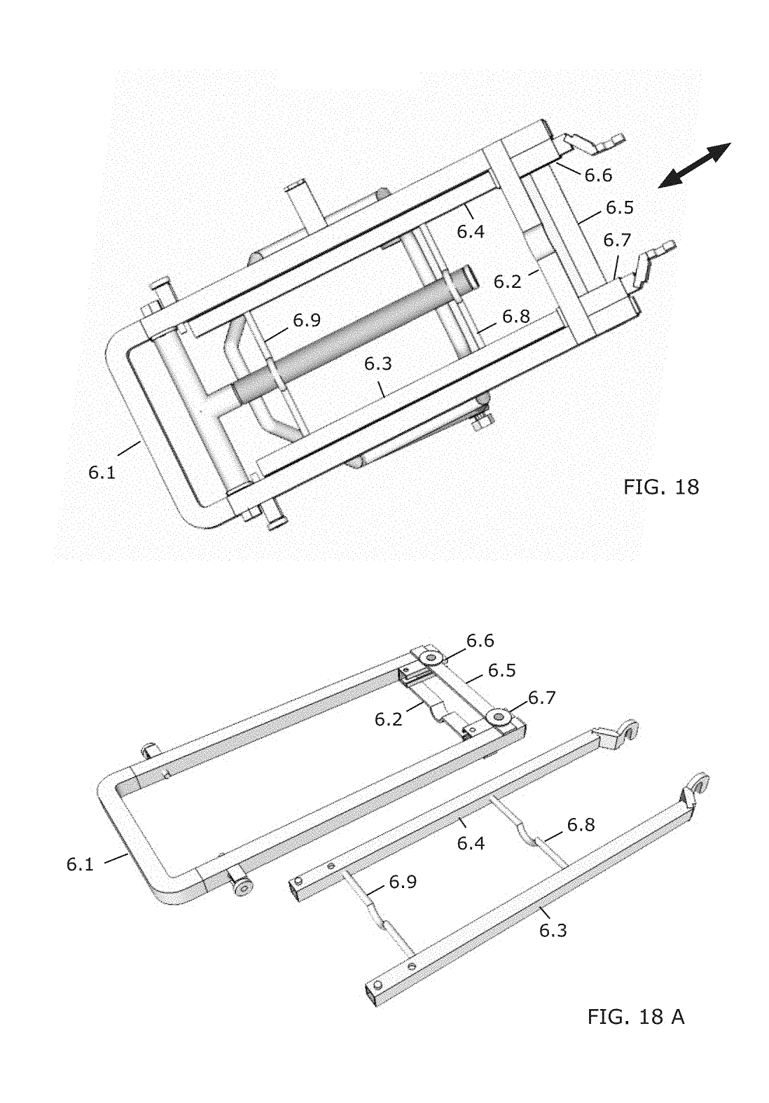

FIGS. 18 and 18A show the alternative method of fabrication of this invention comprising a telescoping mechanism for the expansible platform. The numbered items in these drawings represent components that are uniquely different from the preferred folding model as described in full in this application.

1. A bicycle trailer and rear article carrier combination, said combination comprising:
a. a platform to hold cargo;
b. said platform is expansible;
c. a support frame attached to bicycle rear wheel axle;
d. said support frame convertible to trailer tow apparatus;
e. said support frame secured to bicycle rear wheel axle by means of elongated lock nut and bolt swivel mechanism;
f. said support frame hook to store trailer wheel;
g. a clamp bracket securing said combination to bicycle;
e. a single trailer wheel;

2. A bicycle trailer and rear article carrier combination of claim 1, wherein said rear article carrier comprises:
a. a primary and secondary platform;
b. said primary platform substantially rectangular consisting of a multiplicity of tubular sections, said sections preferably rectangular, whereby three sides of the rectangle are formed by means of bending of said tubular material into a U-formation, and the fourth end formed by welded flat bar;
c. said secondary platform substantially rectangular with a multiplicity of tubular sections connected by welded cross-members; whereby the outside witdth dimension of said tubular sections is no greater than the inside witdth dimension of the primary platform and no smaller than to leave a gap of a millimeter or two between the two platforms when folded together;
d. said secondary platform is connected to and revolves 180 degrees around a cross-member bolt at one end of the primary platform; in expanded position 180 degrees is achieved as platform is stopped and comes to rest against primary platform cross flat bar, and a spring bolt located on the secondary platform engages and locks both platforms together; in collapsed position whereby both platforms' respective top and bottom sides are coplanar, 180 degrees stop is achieved as a spring pin engages and locks into primary platform;
e. said combined platforms are attached to support frame by means of T-shape axle assembly connected to one end of said primary platform whereby the longer vertical section of said T-shape axle is bolted to the support frame by means of u-bolts;
f. said T-shape axle's vertically rotatable section length is between 55 and 70% of the length of the primary platform;

3. A bicycle trailer and rear article carrier combination of claim 1, wherein said trailer comprises:
a. an expansible platform permitting a cargo load footprint of 24 inches in length and 10 inches in width or greater;
b. a quick-release wheel of approximately 12″ in diameter;
c. a T-shape axle assembly with requisite swing limitation mechanism;
d. vertically rotatable section of said T-shape axle fitted with either bushing or ballbearing components to minimize torsional instability;
e. a bicycle rear wheel axle fastening assembly permitting vertical articulation of said trailer;
f. a tubular tow frame that rotates around the bicycle rear wheel axle whereby said tow frame converts to platform support frame in upright position;
g. said tow frame comprising a multiplicity of tubes of which two primary tube sections each form a substantially V-shape whereby the open ends of said V-shapes are welded together at an off-set of approximately 28 degrees, thereby forming a third V-formation on a plane perpendicular to previous said V-shapes;

4. A bicycle trailer and rear article carrier combination of claim 1, wherein said clamp bracket comprises:
a. adjustable sliding plate and sliding bar plus a multiplicity of drilled holes to permit height and width adjustments accommodating variable bicycle seat stay designs;

5. A bicycle trailer and rear article carrier combination of claim 1, wherein said trailer and article carrier comprise:
a. a primary and secondary expansible platform whereby the expansible method entails a telescoping mechanism;
